(19) United States
(12) Patent Application Publication
(10) Pub. No.: US 2024/0051724 A1
(43) Pub. Date: Feb. 15, 2024

(54) A CONTAINER

(71) Applicant: SANDS INNOVATIONS LTD, Forest Glen, Queensland (AU)

(72) Inventor: Jacob REDRUP, Forest Glen, Queensland (AU)

(73) Assignee: SANDS INNOVATIONS LTD, Forest Glen, Queensland (AU)

(21) Appl. No.: 18/269,332

(22) PCT Filed: Dec. 22, 2021
(86) PCT No.: PCT/AU2021/051541

§ 371 Date: Jun. 23, 2023

(30) Foreign Application Priority Data
Dec. 23, 2020 (AU) 2020904819

(51) Int. Cl. B65D 75/58; B65D 75/36; A61J 1/03

(52) U.S. Cl. CPC B65D 75/585; B65D 75/367; A61J 1/035; B65D 2215/04; B65D 2221/00; B65D 2575/366

(57) ABSTRACT

A container having a body having a first end and a second end that can be folded together about a fold axis, the body having a base wall connected to an upper wall by a side wall, the base wall, upper wall and side wall defining a cavity for storing a product, is formed therebetween, the body having a fracturable portion that is adapted to fracture, when the first and second ends are folded together about the fold axis, to produce an opening having a size that is smaller than a narrowest dimension of the product, the body being deformable to increase the size of the opening to enable the product to be dispensed from the container, wherein the container provides restricted access to the product until the body has been folded and deformed.

### FIELD OF THE DISCLOSURE

The present disclosure relates to a container for a product that provides restricted access to the product contained within.

### BACKGROUND

In some instances, it is desirable to provide a container that provides restricted access to the product contained within the container. This is particularly relevant to products, such as medicines, that may be harmful or toxic if ingested. To restrict access to a container, it is typical to provide an arrangement involve a plurality of opening steps, each of which must be successively accomplished before the product can be removed from the container

One example of a restricted access container is a bottle with a safety cap. Safety caps are typically found on many household items such as bleach and bottled medicine. Safety caps typically comprise an inner cap having a female thread for threaded engagement with a male thread on the neck of a bottle and an outer cap arranged coaxially around the inner cap. The inner and outer caps have mutually interlocking engagement portions that are resiliently biased into a disengaged configuration. The safety cap is opened by axially displacing the outer cap relative to the inner cap to cause the engagement portions to interlock. Once interlocked, rotation of the outer cap drives rotation of the inner cap such that the inner cap can be unscrewed from the bottle.

Restricted access blister card packages are also known. Blister card packages typically comprise a thermoformed plastic web having a plurality of cavities formed therein for storing tablets and the like, and a backing of aluminium foil to enclose the tablets within the cavity. The backing is punctured to access the tablets stored within the cavities. Restricted access blister card packages are opened in the same way as standard blister card packages insofar as they have a puncturable backing of aluminium foil. However, they may also include a paperboard covering over the backing that is perforated to form a tab. The tab must be peeled back on the paperboard cover to expose the backing before it can be punctured.

Containers of the type discussed above have several disadvantages. Safety caps comprise an assembly of complex injection moulded parts and are therefore expensive to manufacture. Furthermore, bottles containing safety caps are unsuitable for dispensing a single product (i.e. one tablet) at a time. Whilst the above described containers are suitable for preventing access to the contents stored therein, the steps involved in opening these containers are often too difficult to be performed by elderly or infirm persons as they require strength and dexterity. For example, safety caps require a significant amount of strength to simultaneously axially displace and twist the outer cap. Restricted access blister packs also require a significant amount of dexterity to locate and peel back the tab on the paperboard cover.

It is therefore desirable to provide an improved and/or alternative container that, through its construction, restricts access to the product contained within the container. It is also desirable to provide a container which overcomes one or more of the problems associated with the prior art.

Any discussion of documents, devices, acts or knowledge in this specification is included to explain the context of the invention. It should not be taken as an admission that any of the material formed part of the prior art base or the common general knowledge in the relevant art on or before the priority date of the claims herein.

### SUMMARY OF THE INVENTION

An aspect of the present invention provides a container comprising a body having a first end and a second end that can be folded together about a fold axis, the body having at least one wall that defines a cavity for storing a product, the body having a fracturable portion that is adapted to fracture, when the first and second ends are folded together about the fold axis, to produce an opening having a size that is smaller than a narrowest dimension of the product, the body being deformable to increase the size of the opening to enable the product to be dispensed from the container, wherein the container provides restricted access to the product until the body has been folded and deformed.

The present invention comprises a multi-step opening. An advantage of this multi-step opening process is that it is cognitively difficult enough to prevent access by a juvenile, for example, whilst being physically easy enough for an elderly or infirm person to access. It has been found that the container according to the present invention is surprisingly challenging to open through trial and error. In other words, it is difficult to guess the opening sequence involving folding the body and then squeezing the folded body. This feature therefore makes the container difficult to open for juveniles, for example. However, it has also been found that the opening sequence involving folding the body and then squeezing the folded body requires very little strength and dexterity to perform. This feature makes the container physically easy enough for an elderly or infirm person to access.

According to an embodiment, the body is deformable by being squeezed in a direction parallel to the fold axis. The body may be divided about the fold axis into a product containing portion and a product absent portion. However, it is also envisaged that the body may be divided about the fold axis into two product containing portions. The terms ‘product containing portion’ and ‘product absent portion’ refer to the part of the container that contains the product, i.e. a tablet, and the part of the container that does not contain the product, respectively.

According to an embodiment, the cavity is separated into a plurality of cavities. The cavity may be separated into a product containing cavity, located within the product containing portion, and a product absent cavity. However, it is also envisaged that the cavity may be separated into two or more product containing cavities. For example: there may be one product containing cavity and one product absent cavity; or two product containing cavities; or two product containing cavities and one product absent cavity. The terms ‘product containing cavity’ and ‘product absent cavity’ refer to the cavity in the container that contains the product, i.e. a tablet, and the cavity of the container that does not contain the product, respectively.

According to an embodiment, the at least one wall may comprise a base wall, an upper wall and a side wall that together define the cavity.

According to an embodiment, the cavity is separated into a product containing cavity and a product absent cavity by a barrier formed. The barrier may be formed on the upper wall. Alternatively, the barrier may be formed on the side wall or base wall. The barrier may be located between ends of the fracturable portion. The barrier may be integral with the fracturable portion. Suitably, the barrier may be defined by a V-shaped groove. However, other shaped grooves such as U-shaped or W-shaped are also conceived. The groove has sides extending inwardly from the upper wall towards the fold axis. The angle between the sides of the groove may be an acute angle. The term ‘acute angle’ means an angle that measures between 90° and 0°. The barrier may be at least partially fractured as the first and second ends are folded together about the fold axis. It has been found that an acute angle is the optimal angle for concentrating stresses in the fracturable portion to at least partially fracture the barrier when the first and second ends are folded together about the fold axis. The barrier may be completely fractured by deforming the body which increases the size of the opening—this feature ensures that the opening has a size that is greater than the narrowest dimension of the product such that the product can be easily dispensed from the container.

According to an embodiment, a portion of the upper wall on the product absent portion is recessed inwardly into the product absent cavity and secured to an inner surface of the base wall, such that when the body is deformed, after being folded, the base wall is pulled away from the product containing cavity to increase the size of the product containing cavity. This feature reduces the risk of the base wall obstructing the path of the product as it is released from the container. It is also envisaged that, as the body is deformed, the base wall may be pulled away from the product containing cavity and the size of the opening may also increase in a direction transverse to the fold axis. This feature further reduces the risk of the base wall obstructing the path of the product as it is dispensed from the container.

According to embodiments, the portion of the upper wall that is secured to the inner surface of the base wall and the base wall itself are bonded and sealed together through one of heating, ultrasonic welding, pressure sensitive adhesive, heat actuated adhesive or another type of adhesive.

According to an embodiment, the container further comprises a flange that extends around at least part of a periphery of the side wall. The angle between the flange and the side wall may be about 120° to about 160°, preferably about 130° to about 150°, more preferably about 135°. When the first end and the second end are folded together about the fold axis, parts of the flange can be gripped between the index finger and the thumb and squeezed together in a direction parallel to the fold axis to deform the body. It has been found that the above described angular range is optimal for transferring force through the flange to the side wall to deform the body when the flange is squeezed in this fashion. The above described angular range ensures that the applied force is transferred in a direction perpendicular to the plane defined by the base wall and assists in increasing the size of the opening in a direction transverse to the fold axis. As such, a lower squeezing force is required to deform the body and dispense the product. This feature makes it easier for an elderly or infirm person to access the product in the container.

According to an embodiment, the flange has indentations that form gripping portions when the first end and the second end are folded together about the fold axis, such that the gripping portions can be squeezed together in a direction parallel to the fold axis to deform the body. The gripping portions increase friction between the index finger and thumb of the person and the flange of the container. The gripping portions may be in the form of at least one of grooves, notches and/or textured surfaces. The gripping portions enable an increased purchase on the flanges which assist elderly or infirm persons in gripping and squeezing the flange.

According to an embodiment, the flange has indentations defining surfaces that are angled relative to each other when the first end and the second end are folded together about the fold axis, wherein the angle is less than or equal to about 75°. It has been found that the above described angular range is optimal for transferring force from the flange to the side wall to deform the body when the flange is squeezed in this fashion. The above described angular range ensures that the applied force is transferred correctly to assist in increasing the size of the opening in a direction transverse to the fold axis. As such, a lower squeezing force is required to deform the body and dispense the product. This feature makes it easier for an elderly or infirm person to access the product in the container.

According to embodiments, the flange is affixed to the base wall to seal the cavity. According to embodiments, the base wall is bonded and sealed to the flange through one of heating, ultrasonic welding, pressure sensitive adhesive, heat actuated adhesive or another type of adhesive. The flange may include an enlarged portion, preferably an enlarged flange width, directly adjacent to the fracturable portion on the body.

According to an embodiment, the base wall has an increased width in a direction from the respective first and second ends towards the fold axis. This feature enables the container to flare outward towards the opening to help guide product out of the opening when it is dispensed.

The force required to fracture the fracturable portion is dependent on a number of factors, including the type of material from which the fracturable portion is manufactured, thickness of material and shape and size of the fracturable portion. It is preferred that the force required to fracture the fracturable portion is sufficient that unintentional fracturing of the fracturable portion is avoided during transport or regular handling of the container.

‘Sufficient force’, as used herein, is the amount of force at or above which the fracturable portion is adapted to fracture along its break path. If forces below a sufficient force are applied, the fracturable portion will not fracture and the body/container will remain in an unopened state. Preferably, when forces that exceed the sufficient force are applied, the fracturable portion will fracture at one or more initiating fracture point(s) and then along the break path until the entire break path has fractured and the body is in an opened state. Opening the body by fracturing along the break path may be performed by a one- or two-handed action by the user.

The ‘break path’ is a defined path along which the body fractures. In other words, the beak path is the path a fracture will take when the body is opened. In the above aspect, the break path will follow a line defined by the fracturable portion. The break path may be a straight line, a curved line or a series of straight or curved lines connected end to end. For example, the break path could have the appearance of a square wave or a sinusoidal wave. A ‘fracturable portion’ is the portion of the body of the container which fractures.

According to embodiments, the fracturable portion may include at least one fracture conductor—particularly if the break path is a curved line. The at least one fracture conductor may be in the form of a localised change of depth of the bend, where the fracture conductor comprises a bend. Preferably, the at least one fracture conductor is in the form of a localised change of cross-sectional shape of the bend. Optionally, the fracturable portion is formed from a crystallisable material. The at least one fracture conductor may be a localised change of the degree of extent of crystallisation.

According to embodiments of the present disclosure, the fracturable portion extends between a first location located along the flange and a second location located along the flange that is distanced from the first location. The fracturable portion extends across the body from the first location to the second location. The fracturable portion may be formed on the upper wall and side wall or solely on the upper wall.

According to embodiments, the fracturable portion includes at least one fracture initiator. The fracture initiator is a location where the fracturable portion will initially fracture when a sufficient force is applied to the container. A fracture may then propagate outwardly from the location of the fracture initiator along the fracturable portion, in one or more directions, until the entire fracturable portion is fractured, as desired.

The first product may be a single product. Alternatively, the product may comprise more than one individual product. Where the first product comprises more than one product, the respective products may be the same or different products. The product may be any desired product and can be selected from, but not limited to, any of the following: a solid material, a tablet, a substance, a powder, a granular material, a reactive material, a liquid, a suspension, a drug, a medicine, a pharmaceutical product, a chemical product, a gas or other fluid, or a combination product which includes more than one previously defined product, such as a liquid centre tablet with a solid or flexible outer substrate. The product is not limited to consumable items. For example, the product may be a battery or a bullet.

According to embodiments, the body may be formed by at least one of sheet thermoforming, injection moulding, compression moulding, extrusion blow moulding, blow moulding or additive manufacturing, such as, but not limited to, 3D printing.

According to embodiments, a thickness of at least one of the upper, side and base walls is substantially constant over the entire body including the fracturable portion.

The thickness of at least one of the upper, side and base walls may be dictated by the product being held, the material from which the respective wall is formed and/or the dimensions and shape of the body. Optionally, the thickness of at least one of the upper, side and base walls is about 300 μm to about 600 μm. For example, the thickness of at least one of at least one of the upper, side and base walls may be about 350 μm to about 550 μm. The thickness of at least one of the upper, side and base walls may be about 400 μm to about 550 μm. The thickness of at least one of the upper, side and base walls may be about 400 μm to about 500 μm. The thickness of at least one of the upper, side and base walls may be about 300 μm. The thickness of at least one of the upper, side and base walls may be about 350 μm. The thickness of at least one of the upper, side and base walls may be about 400 μm. The thickness of at least one of the upper, side and base walls may be about 450 μm. The thickness of at least one of the upper, side and base walls may be about 500 μm. The thickness of at least one of the upper, side and base walls may be about 550 μm. The thickness of at least one of the upper, side and base walls may be about 600 μm.

Another aspect of the present invention provides a method of manufacturing a container, comprising: forming a base wall; forming an upper wall; and forming a side wall; forming a fracturable portion in at least one of the upper, side and base walls; connecting the upper wall to the side wall to define a recess; depositing a product into the recess and sealing the recess with the base wall to define a cavity in which the product is retained.

According to an embodiment, a flange is formed around the periphery of the side wall defining a filling opening to the recess. Sealing the recess with the base wall may be achieved by bonding the base wall to the flange. The base wall may be bonded and sealed to the flange through one of heating, ultrasonic welding, pressure sensitive adhesive, heat actuated adhesive or another type of adhesive.

The method may further comprise the step of sterilising at least one of the upper, side and base walls. The sterilisation step may be carried out through one or more of: aseptic manufacturing, ultraclean manufacturing, or secondary sterilisation such as gamma irradiation, ethylene oxide (EtO) gas or application of heat.

According to embodiments, at least one of the upper, side and base walls are formed from a material comprising at least one of: polystyrene, polypropylene, polyethylene terephthalate (PET), amorphous polyurethane terephthalate (APET), polyvinyl chloride (PVC), high density polyethylene (HDPE), low density polyethylene (LDPE), polylactic acid (PLA), bio material, mineral filled material, thin metal formed material, acrylonitrile butadiene styrene (ABS), Cyclic Olefin Co-Polymer (COC), Polyether Ether Ketone (PEEK) and laminate.

According to embodiments, at least one of the upper, side and base walls are formed by at least one of sheet thermoforming, injection moulding, compression moulding, extrusion blow moulding, blow moulding or 3D printing.

The terms ‘upper’, ‘base’ and ‘side’ as used herein are understood as having regard to the positioning of the feature in relation to the container and specifically to reference the body or package to which an element is referenced.

It is understood that any of the individual features provided above or described below or shown in the accompanying figures may themselves be the subject of independent or dependent claims. The features as described herein may be utilised in any combination as would provide a beneficial outcome and no single embodiment is considered on its own to be limiting to the scope of the invention.

### BRIEF DESCRIPTION OF THE DRAWINGS

Embodiments of the present disclosure will now be described, by way of non-limiting example, with reference to the accompanying drawings, in which:

FIG. 1A shows a perspective view of a container according to an embodiment of the present invention in the unopened condition;

FIG. 1B shows a top view of the container of FIG. 1A;

FIG. 1C shows a front view of the container of FIG. 1A;

FIG. 1D shows a sectional view of the container of FIG. 1C along the line A-A;

FIG. 1E shows a top view of the container of FIG. 1A in the folded configuration;

FIG. 1F shows an enlarged view of the fracturable portion shown in FIG. 1D;

FIG. 2A shows a perspective view of a container according to an embodiment of the present invention in the partially folded condition;

FIG. 2B shows a front view of the container of FIG. 2A;

FIG. 2C shows a sectional view of the container of FIG. 2B along the line B-B;

FIG. 3A shows a perspective view of a container according to an embodiment of the present invention in the fully folded condition;

FIG. 3B shows a front view of the container of FIG. 3A;

FIG. 3C shows a sectional view of the container of FIG. 3B along the line C-C;

FIG. 4A shows a perspective view of a container according to an embodiment of the present invention in the deformed condition;

FIG. 4B shows a front view of the container of FIG. 4A;

FIG. 4C shows a sectional view of the container of FIG. 4B along the line D-D;

### DESCRIPTION OF PREFERRED EMBODIMENTS

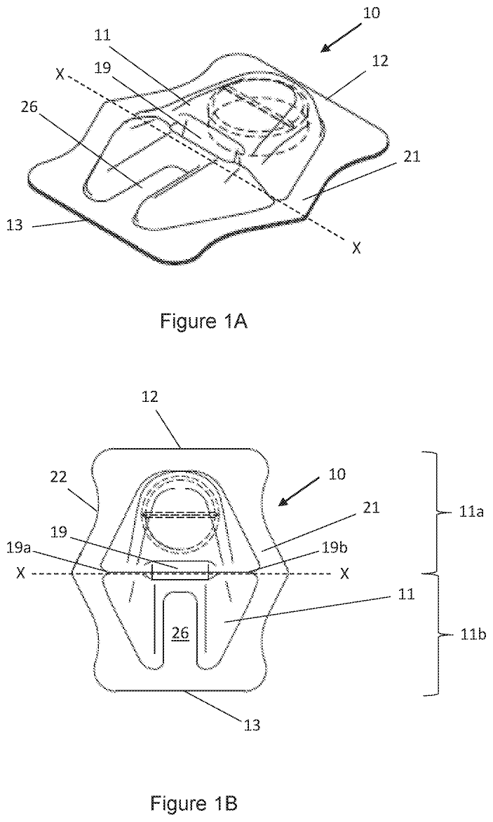

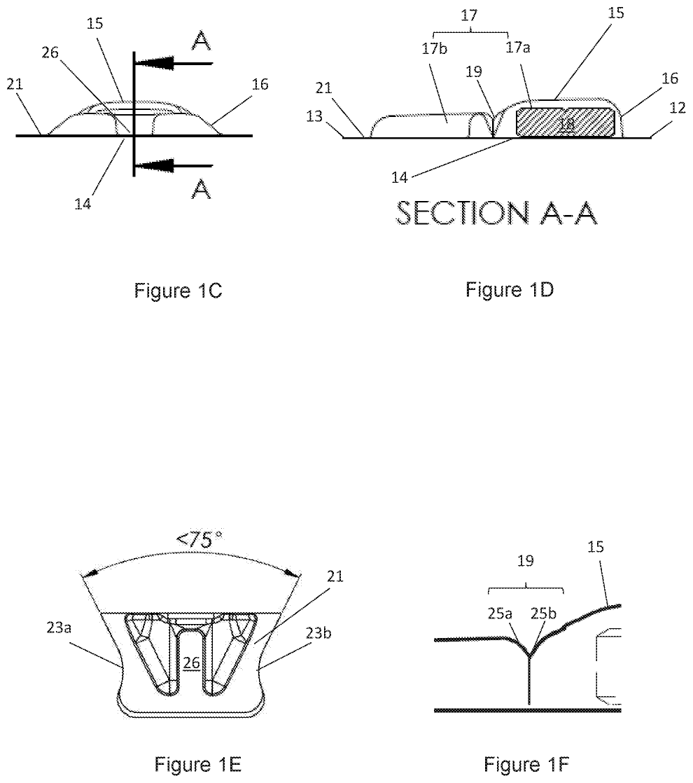

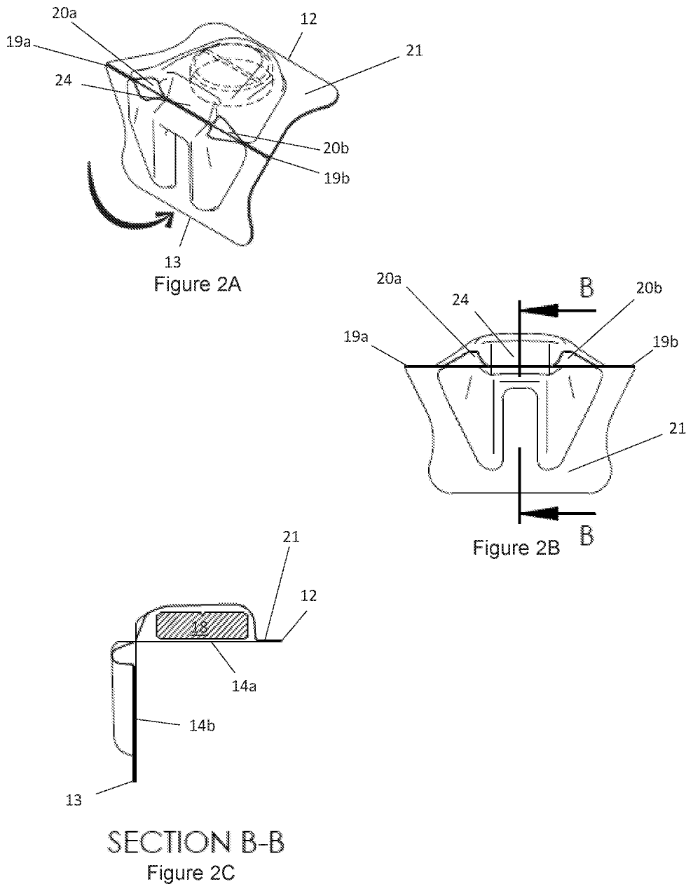

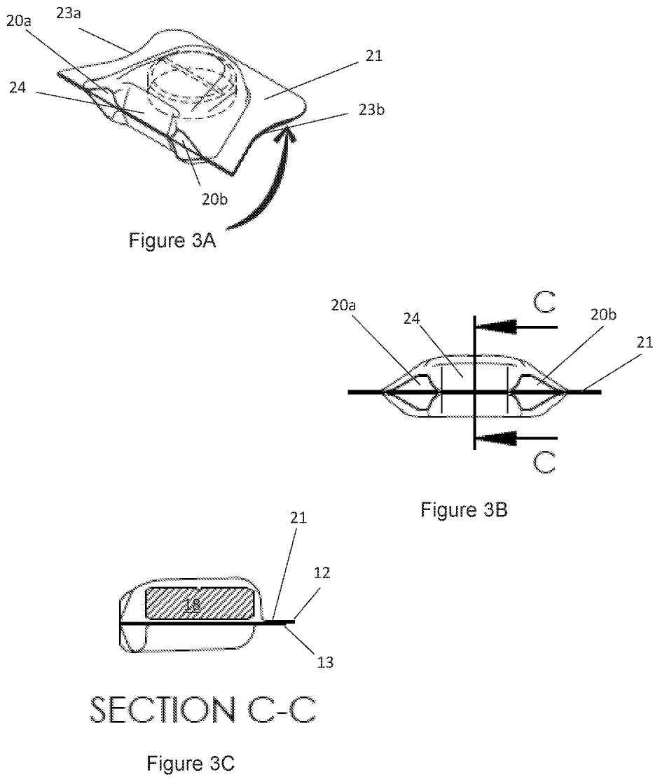

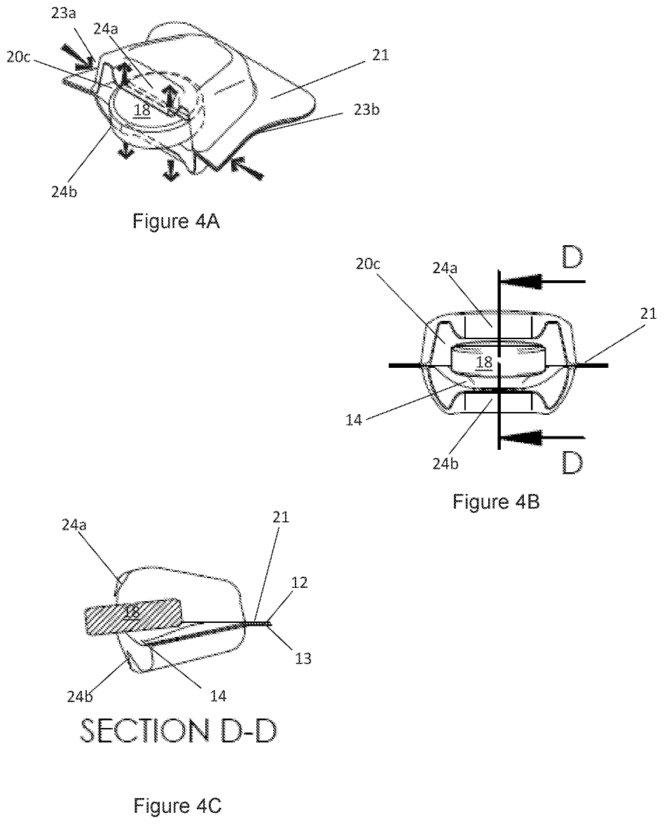

FIGS. 1A to 4C show a container 10 according to an embodiment. As shown in FIGS. 1A to 1F, the container 10 comprises a body 11 which is substantially elongate in a longitudinal direction of the container 10 between a first end 12 and a second end 13 compared to a width in a perpendicular direction of the body 11. The body 11 is foldable about a fold axis X-X which extends in a direction perpendicular to the longitudinal direction of the container 10 across the body 11. The first end 12 and the second end 13 can be folded together about the fold axis X-X. As shown in FIGS. 1C and 1D, the body 11 has a base wall 14 connected to an upper wall 15 by a side wall 16. The base wall 14 generally defining a plane and the upper wall 15 is offset from the plane such that a cavity 17, for storing a product 18, is formed therebetween. The body 11 has a fracturable portion 19 that is adapted to fracture, when the first 11 and second ends are folded together about the fold axis X-X (as illustrated in FIGS. 2A to 3C), to produce an opening 20a, 20b having a size that is smaller than a narrowest dimension of the product 18, as will later be described. Once folded, the body 11 is deformable (as illustrated in FIGS. 4A to 4C) to increase the size of the opening 20c to enable the product to be dispensed from the container, as will later be described.

The container 11 provides restricted access to the product 18 until the body 11 has been folded and deformed. The advantage of the container 10 according to the present invention is that the opening sequence involving folding the body and then squeezing the folded body is difficult to determine through trial and error. This feature makes the container difficult for a juvenile, or person of limited cognitive faculties, to open. However, it has also been found that the opening sequence involving folding the body and then squeezing the folded body requires very little strength and dexterity to perform. This feature makes the container 10 physically easy enough for an elderly or infirm person to perform. As such, the container 10 according to the present invention is suitable for restricting access for juveniles but also accessible by an elderly or infirm person.

As shown in FIGS. 1A to 1D, a flange 21 extends around the periphery of the side wall 16. As shown in FIG. 1C, the flange 21 is arranged at an angle of about 135° from the side wall 16. It has been found that angle of 135° is particularly effective at allowing force to be transferred through the flange 21 and to the side wall 16 to deform the body 11 when the flange 21 is squeezed in this fashion. This angle ensures that the applied force is transferred in a direction perpendicular to the plane defined by the base wall 14 and assists in increasing the size of the opening 20a, 20b in a direction transverse to the fold axis X-X. As such, a lower squeezing force is required to deform the body 11 and dispense the product 18. This feature makes it easier for an elderly or infirm person to access the product 18 in the container 10.

As shown in FIG. 1B, the flange 21 has indentations 22 that form gripping portions 23a, 23b when the first end 12 and the second end 13 are folded together about the fold axis X-X, as shown in FIG. 1E. The gripping portions 23a, 23b can be squeezed together in a direction parallel to the fold axis to deform the body 11. The gripping portions 23a, 23b have surfaces that are at an angle less than or equal to about 75° relative to each other when in the folded configuration.

As shown in FIG. 1B, the body 11 is divided about the fold axis X-X into a product containing portion 11a and a product absent portion 11b. The product containing portion 11a is located towards the first end 12 of the body 11 and the product absent portion 11b is located towards the second end 13 of the body. Similarly, the cavity 17 is separated into a product containing cavity 17a, located within the product containing portion 11a, and a product absent cavity 17b, located within the product absent portion 11b, by a barrier 24 (as shown in FIGS. 2A to 3C) formed in the upper wall 15. The barrier 24 is located between ends 19a and 19b of the fracturable portion 19 and is formed integrally with the fracturable portion 19. The barrier 24 is at least partially fractured as the first and second ends 12, 13 are folded together about the fold axis X-X to form two openings 20a, 20b (see FIGS. 2A to 3C) located proximal the ends 19a, 19b of the fracturable portion 19.

As shown in FIG. 1F, the fracturable portion 19 is in the form of a V-shaped groove in the body 11, the groove having sides 25a, 25b extending inwardly from the upper wall 15 towards the fold axis X-X. An angle between the sides 25a, 25b of the V-shaped groove is an acute angle, i.e. between 90° and 0°. It has been found that an acute angle is the optimal angle for concentrating stresses in the fracturable portion 19 when the first and second ends 12, 13 are folded together about the fold axis X-X.

As shown in FIGS. 1A, 1B, 1C and 1E, a portion 26 of the upper wall 15 on the product absent portion 11b is recessed inwardly into the product absent cavity 17b and secured to an inner surface of the base wall 14. This feature ensures that when the body is deformed, after being folded, the base wall 14 is pulled away from the product containing cavity 17a to prevent the base wall 14 from obstructing the path of the product 18 out of the opening. This feature reduces the risk of the base wall obstructing the path of the product as it is dispensed from the container.

As shown in FIG. 1B, the base wall 14 is substantially ‘bowtie’ shaped and has an increased width in a direction from the respective first and second ends 12, 13 towards the fold axis X-X. In other words, the container flares outwards towards the fold axis X-X. This shape ensures that when the body 11 is deformed in the folded condition, as shown in FIGS. 4A to 4C, the product 18 is guided out of the product containing cavity 17a.

U.S. Pat. No. 8,485,360, of the present applicant, provides a container with a so-called ‘snap feature’, fracturable along a break path. The wall of the container may have a generally constant wall thickness across the break path. The body of the container is configured to concentrate stress along the break path by increasing the distance (y) between a neutral axis and the base surface of the bend and decreasing the second moment of area (lx) at the break path. The container shown in the accompanying figures preferably include a fracturable portion which is adapted to fracture in a manner similar to that described in U.S. Pat. No. 8,485,360, the contents of said patent being incorporated herein by reference. Of course, a person skilled in the art will understand that other opening mechanisms may be utilised on the body and that the scope of the present disclosure is not restricted to a container which includes one or more fracturable portions as described in U.S. Pat. No. 8,485,360. However, said fracturable portion described in said US patent provide in this context a preferred manner of opening the container.

Further, PCT patent publication no. WO/2018/187824, also of the present applicant, describes a fracturable container similar to that of U.S. Pat. No. 8,485,360 and additionally including one or more fracture conductors. The contents of WO/2018/187824 being entirely incorporated herein by reference. The fracture conductors are provided along the fracturable portion of the container of WO/2018/187824 and enable a consistent and correctly directed break path to be formed along the fracturable portion when the container is opened. According to the present disclosure it is envisaged that in some situations it may be desirable to include one or more fracture conductors along the fracturable portion of the body to provide a desired break path, such as where the respective break path must traverse a number of directions or where the break path traverses a comparatively long distance.

The process for opening the container 10 is described as follows with reference to FIG. 2A through to FIG. 4C.

The container 10 in the unopened condition, as shown in FIGS. 1A to 1F, is gripped between the first and second ends 12, 13 by the thumb and index finger. By squeezing the container 10 between the thumb and index finger, the body 11 is folded about the fold axis X-X such that a section of the base wall 14b in the product absent portion 11b is at an angle to a section of the base wall 14a in the product containing portion 11a. Once the angle between two sections of the base wall 14a, 14b is less than about 90°, a fracture is initiated at respective first and second ends 19a, 19b of the fracturable portion 19 to produce respective first and second openings 20a, 20b. In this partially folded condition, the fracture terminates at the barrier 24. In other words, the barrier 24 prevents the fracture from propagating all the way through the body 11 from the first end 19a to the second end 19b of the fracturable portion 19. As can be seen from FIGS. 2A to 2C the first and second openings 20a, 20b are too small for the product 18 to be dispensed therethrough.

The body 11 is then folded about the fold axis X-X such that two sections of the base wall 14a, 14b are substantially parallel to each other, as shown in FIGS. 3A to 3C. In this fully folded condition, the barrier 24 remains intact. In other words, barrier 24 continues to prevent the fracture from propagating from the first end 19a to the second end 19b of the fracturable portion 19. As can be seen from FIGS. 3A to 3C the first and second openings 20a, 20b remain too small for the product 18 to be dispensed therethrough. As can be seen in FIG. 3A, in the fully folded condition the indentations 22 form gripping portions 23a, 23b.

In the fully folded condition shown in FIGS. 3A to 3C, the gripping portions 23a, 23b can be gripped by the thumb and index finger. Squeezing the container 10 between the thumb and index finger, in a direction parallel to the fold axis X-X (as shown by arrows), deforms the body 11. Once a sufficient amount of force is exerted through this squeezing action, the fracture is propagated through the barrier 24 which separates the barrier 24 in to two tongues 24a, 24b and the two openings 20a, 20b merge to form a single third opening 20c, as shown in FIG. 4A to 4C. The third opening 20c has an area that is greater than combined area of the first and second openings 20a, 20b and is large enough to accommodate the product 18 therethrough. As previously discussed, the flange 21 is arranged at an angle of about 135° from the side wall 16. It has been found that angle of 135° is particularly effective at allowing force to be transferred through the flange 21 and to the side wall 16 to deform the body 11 when a squeezing action is applied to the gripping portions 23a, 23b. This angle increases the transferral of force in a direction perpendicular to the plane defined by the base wall 14 which ensures separation of the barrier 24. As such, a lower squeezing force is required to deform the body 11 and dispense the product 18. This feature makes it easier for an elderly or infirm person to access the product 18 in the container 10.

In the FIG. 4A to 4C deforming the body 11 further increases the size of the third opening 20c. As previously discussed, the portion 26 of the upper wall 15 on the product absent portion 11b is recessed inwardly into the product absent cavity 17b and secured to an inner surface of the base wall 14. As the body 11 is deformed, the base wall 14 is pulled away from the product containing cavity 17a, as shown in FIG. 4C. Pulling the base wall 14 away from the product containing cavity 17a increases the size of the third opening 20c in a direction perpendicular to the fold axis X-X. This feature prevents the base wall 14 from obstructing the path of the product 18 as it is dispensed out of the opening 20c.

A method of manufacturing the container 10 of the above described embodiments may include the following steps. The upper wall 15, side wall 16 and flange 20 can be integrally formed in a vacuum forming process. The vacuum forming process involves inserting a ‘bowtie’ shaped blank made from polymer into a vacuum forming apparatus. The blank is heated and deep drawn in a die in the vacuum forming apparatus to produce a tray with recesses formed therein. However, it is also envisaged that the tray may be formed by any one or more of: thermoforming, injection moulding, compression moulding, extrusion blow moulding, blow moulding, or 3D printing, or any other suitable manufacturing method. A product 18 may then be inserted and contained within the recess of the tray. A ‘bowtie’ shaped cover in the form of a polymer film web is secured to the flange in order to enclose the product within the recess. Once secured to the tray, the cover defines the base wall 14 of the container 10. The cover may be secured to the flange 20 with the use of ultrasonic welding. However, it is also envisaged that the cover can be bonded and sealed to the flange 20 by any suitable process, including: heating, pressure sensitive adhesive, heat actuated adhesive or another type of adhesive or any suitable sealing technology. It is preferred that the sealing of the container is airtight to prevent or reduce any degradation or contamination of the product 18 within.

According to embodiments, the body 11, may be formed from a material comprising at least one of: polystyrene, polypropylene, polyethylene terephthalate (PET), amorphous polyurethane terephthalate (APET), polyvinyl chloride (PVC), high density polyethylene (HDPE), low density polyethylene (LDPE), polylactic acid (PLA), bio material, mineral filled material, thin metal formed material, acrylonitrile butadiene styrene (ABS), Cyclic Olefin Co-Polymer (COC), Polyether Ether Ketone (PEEK) and laminate.

According to embodiments, the container may be manufactured in a sterile environment or through a sterile manufacturing process. For example, at least one of the upper, side and base walls may be sterilised. A sterile manufacturing process may include aseptic manufacturing or ultraclean manufacturing. Alternatively, the container or any part of the container, such as at least one of the upper, side and base walls, may be subjected to a secondary sterilisation. For example, at least one of the upper, side and base walls may be treated by gamma irradiation, ethylene oxide (EtO) gas or be heat treated.

In interpreting the present disclosure, all terms should be interpreted in the broadest reasonable manner consistent with the context. For example, comprises/comprising and grammatical variations thereof when used in this specification are to be taken to specify the presence of stated features, integers, steps or components or groups thereof, but do not preclude the presence or addition of one or more other features, integers, steps, components or groups thereof.

The embodiment shown in the drawings and described herein are but one of a vast plurality of possible shapes, configurations and/or embodiments of a container within the scope of the present disclosure. It would be clear to a person skilled in the art that the teaching herein can be put to use in any one of a number of embodiments and that the scope of the claimed invention is not restricted by specific features depicted or described herein.

The preceding description relates to features of preferred embodiments of a deformable probe according to the present disclosure. It is contemplated that one or more features may be replaced with equivalent or alternative features. It is therefore to be understood that numerous modifications may be made to the illustrative examples and that other arrangements may be devised without departing from the spirit and scope of the technology. The invention according to the following claims in its broadest sense is not to be limited to the specific features as shown in the accompanying figures or described in the present description.

1. A container comprising
a body having a first end and a second end that can be folded together about a fold axis,
the body having at least one wall that defines a cavity for storing a product,
the body having a fracturable portion that is adapted to fracture, when the first and second ends are folded together about the fold axis, to produce an opening having a size that is smaller than a narrowest dimension of the product,
the body being deformable to increase the size of the opening to enable the product to be dispensed from the container,
wherein the container provides restricted access to the product until the body has been folded and deformed.

2. The container of claim 1, wherein the body is deformable by being squeezed in a direction parallel to the fold axis.

3. The container of claim 1, wherein the body is divided about the fold axis into a product containing portion and a product absent portion.

4. The container of claim 3, wherein the cavity is separated into a product containing cavity, located within the product containing portion, and a product absent cavity, located within the product absent portion, by a barrier.

5. The container of claim 4, wherein the at least one wall comprises a base wall, an upper wall and a side wall that together define the cavity.

6. The container of claim 5, wherein the barrier is formed on the upper wall.

7. The container of claim 5, wherein the fracturable portion is on the upper wall.

8. The container of claim 4, wherein the barrier is located between ends of the fracturable portion.

9. The container of claim 5, wherein the barrier is integral with the fracturable portion and is defined by a V-shaped groove, the groove having sides extending inwardly from the upper wall towards the fold axis.

10. The container of claim 9, wherein an angle between the sides of the V-shaped groove is an acute angle.

11. The container of claim 4, wherein the barrier is at least partially fractured as the first and second ends are folded together about the fold axis.

12. The container claim 4, wherein the size of the opening is increased by completely fracturing the barrier as the body is deformed.

13. The container of claim 5, wherein a portion of the upper wall on the product absent portion is recessed inwardly into the product absent cavity and secured to an inner surface of the base wall, such that when the body is deformed, after being folded, the base wall is pulled away from the product containing cavity to increase the size of the product containing cavity.

14. The container of claim 13, wherein when the base wall is pulled away from the product containing cavity the size of the opening increases in a direction transverse to the fold axis.

15. The container of claim 5, further comprising a flange that extends around at least part of a periphery of the side wall.

16. The container of claim 15, wherein an angle between the flange and the side wall is of about 120° to about 160°, preferably about 130° to about 150°, more preferably about 135°.

17. The container of claim 15, wherein the flange has indentations that form gripping portions when the first end and the second end are folded together about the fold axis, such that the gripping portions can be squeezed together in a direction parallel to the fold axis to deform the body.

18. The container of claim 17, wherein the indentations define surfaces that are angled relative to each other when the first end and the second end are folded together about the fold axis, wherein the angle is less than or equal to about 75°.

19. The container of claim 5, wherein the base wall has an increased width in a direction from the respective first and second ends towards the fold axis.
